(19) United States
(12) Patent Application Publication
(10) Pub. No.: US 2009/0164265 A1
(43) Pub. Date: Jun. 25, 2009

(54) AUCTION PROFIT OPTIMIZATION

(75) Inventors: Fedor Nikitovich Dzegilenko, San Jose, CA (US); Hill Trung Nguyen, San Jose, CA (US); Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 11/961,766

(22) Filed: Dec. 20, 2007

(51) Int. Cl. G06Q 10/00; G06F 17/00

(52) U.S. Cl. 705/7

(57) ABSTRACT

In one example embodiment, a system and method is shown that includes receiving a selected feature wherein the selected feature includes a feature to be included on a webpage. Further, the system and method includes retrieving coefficient data to be used in determining a profit value generated by including the selected feature on the webpage. Additionally, the system and method includes transmitting optimized suggestion data that includes the profit value generated by including the selected feature on the webpage.

### TECHNICAL FIELD

The present application relates generally to the technical field of algorithms and programming and, in one specific example, the generation of data to be used in optimizing a website.

### BACKGROUND

The creative decisions made during the course of designing a website used to sell good and services may be based upon ascetic consideration, business strategy consideration, or other considerations that may seek to maximize profit. This profit may be maximized not only for the party selling the good or services, but also for the party hosting the website (e.g., the site host). Many times these decisions are based upon the past experiences of the party selling the goods or services, or the party hosting the website.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, illustrating the generation of coefficient data.

FIG. 2 is a diagram of a system, according to an example embodiment, illustrating the generation of optimized suggestion data.

FIG. 3 is a diagram showing a Graphical User Interface (GUI), according to an example embodiment, displaying optimized suggestion data.

FIG. 4 is a block diagram of a system, according to an example embodiment, used to generate optimized suggestion data and coefficient data.

FIG. 5 is a flow chart illustrating a method, according to an example embodiment, used to generate optimized selection data.

FIG. 6 is a diagram of a dual-stream flowchart, according to an example embodiment, illustrating a method used to generate optimized suggestion data.

FIG. 7 is a flowchart illustrating the execution of a method, according to an example embodiment, that uses historical data to calculate the coefficients of various seller selected features for a category of goods.

FIG. 8 is a diagram illustrating historical transaction data, according to an example embodiment.

FIG. 9 is a diagram illustrating coefficient data, according to an example embodiment.

FIG. 10 is a flowchart illustrating a method, according to an example embodiment, to compute optimized profit for a particular category of goods utilizing coefficient data.

FIG. 11 is a Relational Data Schema (RDS), according to an example embodiment, illustrating various tables of data that may be utilized by the system and method shown herein.

FIG. 12 shows a diagrammatic representation of a machine in the example form of a computer system, according to an example embodiment.

### DETAILED DESCRIPTION

In some example embodiments, a system and method is shown that use regression modeling to determine an optimal combination of design choices for web page features (e.g., selected features) to be used in the sale of good and services. This system and method may include developing a statistical model to be used to predict a maximal return on investment (e.g., a maximal bid for an on-line auction site). Further, this system and method may be used to develop an optimization methodology to maximize profit for both a designer of a web site and a site host. Additionally, this system and method may be used to provide guidance to the designer of a website with regard to selected features that will optimize the maximal expected profit.

This system and method may be used in the on-line auction context, where an on-line auction is run by a site host. The content displayed on the individual pages that make up this website may be controlled by one or more sellers of good and services. The specifics of how this content is presented on these web pages, may, in one example embodiment, be suggested by the site host through the use of the regression modeling.

Some example embodiments may include the use of a class of algorithms known as censored regression algorithms to generate a series of coefficient values. These coefficient values may be used to weight various features selected during the creation of a web page used to sell goods and services. Design choices may include, for example, bolding the text on a web page, adding certain functionality to the web page, showing certain arrays of photographs, and a number of other suitable selected features. These coefficients may be determined for certain categories of good for sale on a particular website. An example category of goods may be cameras, jewelry, clothing, or some other suitable category of good and services. These selected features may be used to determine a single or combination of selected features that yield a maximum amount of profit for the seller, and, in some cases, the site host. The notion of a maximum amount of profit, and more generally optimization as used herein, may refer to an amount of profit that is greater than an amount of profit had the system and method illustrated herein not been used.

In some example embodiments, once these coefficient values are determined, a separate class of algorithms is applied to evaluate the features selected by the designer of the web page selling goods and services. This class of algorithm is known as a non-linear mixed integer optimization with non-linear constraints algorithms are applied to evaluate selected features in light of maximizing profit. Through the application of an example of this class of algorithms, known as an optimization algorithm, the site host may make suggestions to the designer of the web site as to which combinations of selected features may help maximize profit for the seller of the goods and services, and for the site host.

### Example System

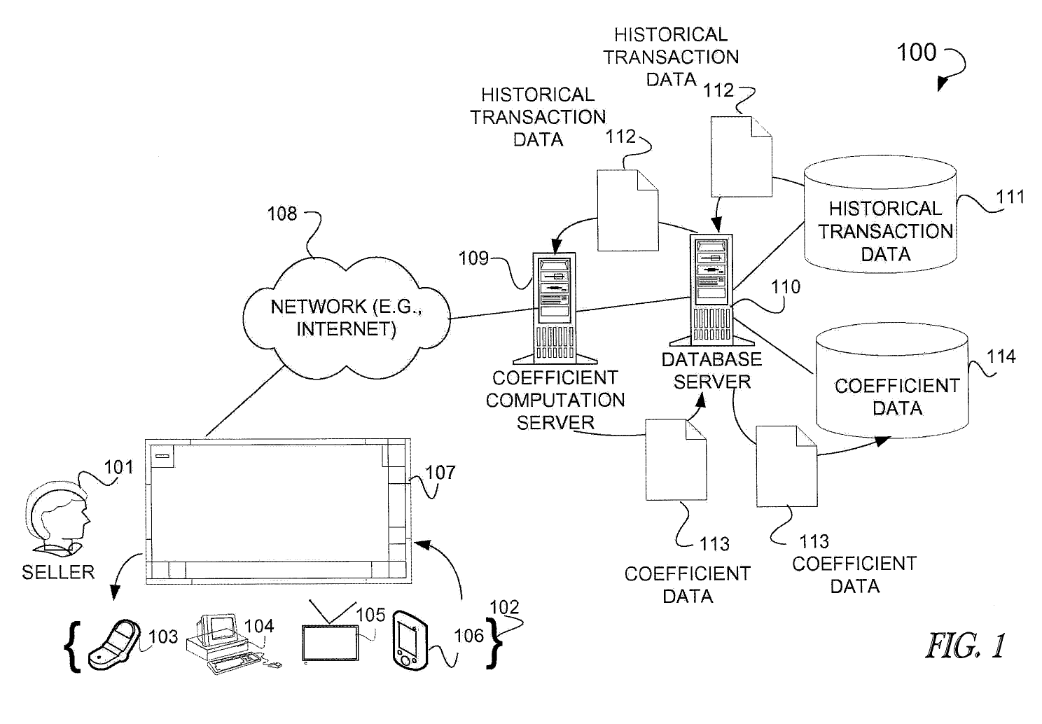

FIG. 1 is a diagram of an example system 100 illustrating the generation of coefficient data. Shown is a seller 101 who may utilize any one of a number of devices 102. These devices 102 may include, for example, a cell phone 103, a computer system 104, a television or monitor 105 and/or a Personal Digital Assistant (PDA) 106 or, for example, a smart phone (not shown). Residing upon one or more of these devices 102 may be a GUI 107 utilized by the seller 101 to receive input from the seller 101. These various devices 102 may further be operatively connected to a network 108 such as, for example, an Internet. This network 108 may further be operatively connected to, for example, a coefficient computation server 109. The coefficient computation server 109 may retrieve historical transaction data 112 from a database server 110. This database server 110 may retrieve this historical transaction data 112 from the historical transaction data 111 database. The historical transaction data 111 database may be, for example, a database implementing an RDS, or an On Line Analytic Processing (OLAP) based schema. In certain example cases, once the coefficient server 109 retrieves the historical data 112 from the database server 110, it applies a likelihood function as a part of a coefficient computational engine to generate coefficient data 113. This coefficient data 113 may be generated with respect to any one of a number of categories of goods. These categories of goods may include, for example, categories such as categories relating to cameras, jewelry, clothing, or some other suitable category of goods or services. This coefficient data 113 may be then be stored by the database server 110 to a coefficient data 114 database. This coefficient data 114 database may be a database modeled using an RDS, or OLAP based schema. In some example embodiments, the coefficient computation server 109 is operatively connected to the database server 110 through a Local Area Network (LAN), a Wide Area Network (WAN), or some other type of network reflecting some type of topology known in the art. This coefficient data 113 may be later retrieved for future use in determining a maximum price for a particular good or service to be advertised on a webpage generated by a seller of a good or service.

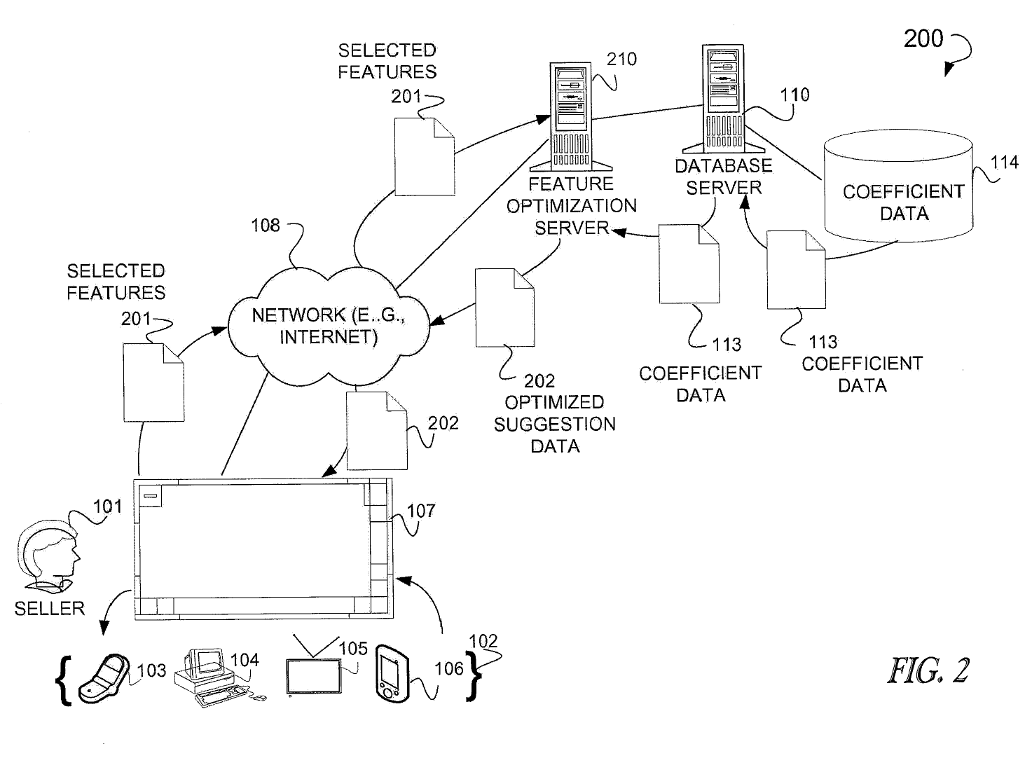

FIG. 2 is a diagram of an example system 200 illustrating the generation of optimized suggestion data. In some example embodiments, the seller 101, utilizing one of the devices 102 and the GUI 107 residing on one of these devices 102, generates selected features 201. The selected features 201 may be formatted as one or more selected features data packets. These selected features 201 are generated through the seller 101 utilizing some type of input device to select certain features that the seller would like to appear as a part of a webpage used to sell a good or service. In certain cases, these features may be graphical features such as bolding, highlighting, or other graphical features associated with a webpage. In other example embodiments, these selected features may include the implementation of certain types of functionality such as, for example, a minimum bid price, maximum bid price, a cutoff date for purchasing a good or service in an auction, or some other suitable type of functionality. The selected features 201 may be transmitted across the network 108 to be received by a feature optimization server 210 that is also operatively connected to the network 108. The feature optimization server 210 may, in turn, implement a feature optimization engine that may utilize, for example, the coefficient data 113. This coefficient data 113 may be retrieved from the coefficient data 114 database via the database server 110. Once this coefficient data 113 is retrieved from the database server 110, the feature optimization server 210 may generate optimized suggestion data 202. This optimized suggestion data 202 may then be transmitted back across the network 108 to be received by one of the devices 102 and ultimately displayed within the GUI 107. Example of optimized suggestion data 202 is shown below.

### Example Interface

In one example embodiment, the designer of a web page (e.g., the seller 101) is provided a number of features that may be used in the designing of a web page. These features may be presented to the designer of the web page via an interactive GUI, whereby using an input device (e.g., a mouse, a keyboard, a light pen, or a touch screen) the designer may make certain design choices. For the purpose of the above referenced optimization algorithm, these features may be considered as independent variables. Example features, and a description thereof, is provided in the below table.

Possible independent variables that affect the maximum price

| Independent | | | Site host fee |
|---|---|---|---|
| Variable Name | Description | Value type | (if applicable) |
| starting_price | Auction starting price | continuous | |
| reserve_price | Secret reserve price | continuous | |
| | | or binary | |
| blemish | Defects of item i | binary | |
| new item | Is the item new or used | binary | |
| auction duration | Original auction duration set | continuous | |
| | by the seller - could serve as | | |
| | a proxy for the number of | | |
| | potential bidders | | |
| positive_feedback | Sellers rating (percentage) | continuous | |
| seller_experience | Total number of feedbacks | continuous | |
| | from unique customers | | |
| | (positive + negative) | | |
| buy_it_now | Whether the item is featured | binary | Depends on |
| | among buy it now items | | buy-it-now |
| | | | price |
| get_it_fast | Whether the item is listed | binary | |
| | among get it fast items. The | | |
| | seller aggress to ship an item | | |
| | within one business day of | | |
| | receiving the cleared | | |
| | payment | | |
| Payment_processor_item | Whether the item of interest | binary | |
| | could be paid for using | | |
| | Payment processor | | |
| gallery | Gallery upgrade feature | binary | $0.35 |
| subtitle | Items subtitle | binary | $0.50 |
| listing_designer | Listing Designer feature | binary | $0.10 |
| value_pack | Gallery + Subtitle + Listing | binary | $0.65 |
| | Designer features | | |
| bold | Bold text feature | binary | $1.00 |
| border | Border option to surround | binary | $3.00 |
| | the listing | | |
| highlight | Option to highlight the | binary | $5.00 |
| | listing | | |
| gallery_featured | Promotional Option which | binary | $19.95 |
| | allows an item to appear in | | |
| | special Featured section | | |
| | above the general Picture | | |
| | Gallery | | |
| featured_plus | Gives a listing preferential | binary | $19.95 |
| | placement in category lists | | |
| | and search results | | |
| propack | Bold + Border + Highlight + Gallery | binary | $29.95 |
| | Feature + FeaturedPlus | | |
| scheduled_listing | An option to list items on | binary | $0.10 |
| | eBay at the desired starting | | |
| | day and time | | |
| 10-day_duration | An option to list an item for | binary | $0.40 |
| | 10 days | | |
| gift_services | List an item as a gift | binary | $0.25 |
| home_page_featured | A chance to rotate into a | binary | $39.95 |
| | special display on eBay's | | |
| | Home page. | | |
| two_categories_listing | Listing in two categories | binary | 1 category |
| | | | fee × 2 |
| picture | Whether a item had a picture | | |
| | associated with it during the | | |
| | auction | | |
| extra_picture | Each additional picture | binary | $0.15 |
| supersize_picture | An ability to display a larger | binary | $0.75 |
| | picture | | |
| picture_pack | An ability to display | binary | $1.00 up to 6; |
| | multiple pictures | | $1.50-7-12 |
| number_similar_auctions | Number of concurrently | continuous | |
| | running auctions for similar | | |
| | items | | |
| shipping_cost | The price the seller charges | continuous | |
| | the buyer to ship an item | | |
| num_items_seller | Number of items the seller | continuous | |
| | lists at the same item i is | | |
| | offered | | |
| insertion_fee (* used in | The price site host charges | continuous | Depends on |
| optimization module only) | for listing an item for sale. | | the starting |
| | | | price |
| Reserve_fee(* used in | A fee for an option not to | continuous | Depends on |
| optimization module only) | sell below a certain price | | reserved price - |
| | | | is fully |
| | | | refunded if |
| | | | item sells. |
| final_value_fee(* used in | The fee charged by site host | continuous | Depends on |
| optimization module only) | off the final sold price | | the sold price |

Once these features are selected, the selected features 201 may be generated and transmitted to the feature optimization server 210 for further processing. As will be more fully shown below, this selected feature 201 may be used by a feature optimization engine implementing the optimization algorithm that uses the predetermined coefficient values. The result of the implementation of this algorithm and coefficient values is the previously referenced optimized suggestion data 202.

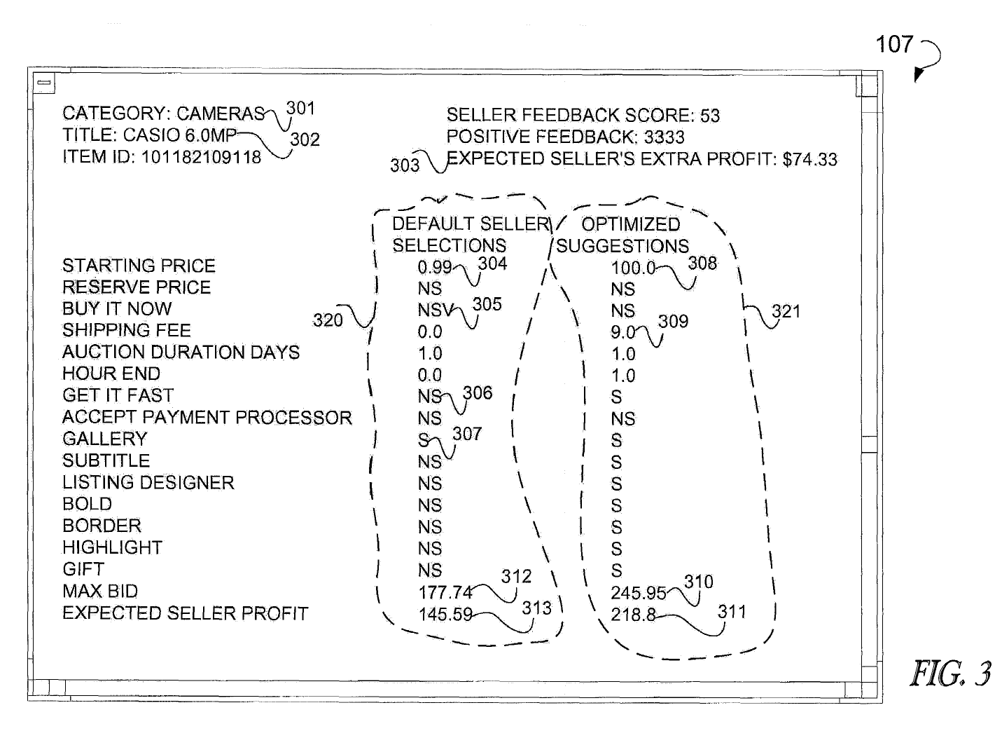

FIG. 3 is a diagram showing an example GUI 107 displaying optimized suggestion data 202. Shown are a number of data fields within the GUI 107. These data fields include, for example, a category field 301 illustrating the category of goods for which optimized suggestion data is provided. Further, a title field 302 is shown relating to the title of the particular good within the category of goods that is being displayed. Here, for example, field 301 describes a category of cameras where as the field 302 describes the brand of camera as being a CASIO™ six mega pixel camera. Further, a field 303 is shown that displays the expected seller's extra profit should the seller decide to select the optimized suggestions provided by the feature optimization server 210. Here for example, the expected seller's extra profit is $74.33 over and above the expected profit based upon the seller's initially selected features. Further, shown is a column 320 displaying the various features that a seller has selected. For example, as displayed in the field 304 a seller has selected a starting price of 99 cents. Further, as displayed in field 312, the system computes the expected seller's max bid of $177.74 based on his initial selections of features. Additionally, as displayed in field 313 there is an expected seller's profit of $145.59. Additional fields that are displayed include fields 305, 306, and 307. With regard to field 305, a Non-Selected Value (NSV) is denoted wherein seller has chosen not to select a feature call “Buy-It-Now.” Field 306 denotes another feature called “Get it Fast” that the seller has chosen not to select as denoted by NS or non-selected. Field 307 references a features called “Gallery” that the seller has selected, as denoted by S or select.

In addition to column 320, a further column 321 is also shown, wherein this column 321 describes optimized suggestions that may be provided as part of the optimized suggestion data 202. These optimized suggestions may be suggested by, for example, the feature optimization server 210 implementing the above referenced feature optimization engine. For example, a field 308 is shown wherein the field 308 displays an optimized suggested starting price of $100. A field 309 is also shown that displays an optimized shipping fee value of $9. Additionally, a field 310 is also shown that illustrates an optimized suggestion max bid price of $245.95. A field 311 is shown that illustrates an expected seller profit of $218.80 should the seller 101 decide to accept the optimized suggestions provided by the feature optimization server 210.

### Example Logic

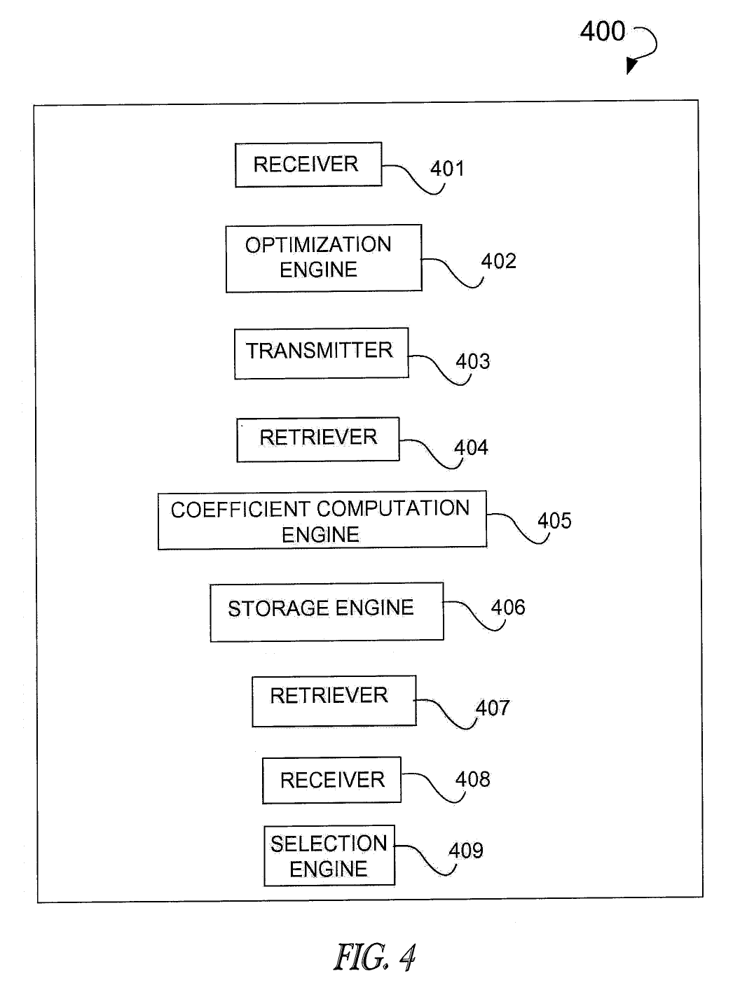

FIG. 4 is a block diagram of an example system 400 used to generate optimized suggestion data and coefficient data. Shown are various blocks that may be implemented in software, hardware, or firmware. Generically referenced blocks 401 through 403 may reside upon the feature optimization server 210, whereas generically referenced blocks 404 through 407 may reside on the coefficient computation server 109. Additionally, generically referenced blocks 408 and 409 may reside on the devices 102. Shown is a receiver 401 to receive a selected feature wherein the selected feature includes a feature to be included on a webpage. Additionally, a feature optimization engine 402 is shown that retrieves coefficient data to be used to determine a profit value generated through the association of the selected feature with the webpage. A transmitter 403 is shown that transmits optimized suggestion data that includes the profit value generated by including the selected feature on the webpage. In some example embodiments, a retriever 404 is illustrated that retrieves historical data including historical transaction data that relates to a good sold. A coefficient computation engine 405 is shown that uses the historical data to calculate the coefficient data. Moreover, a storage engine 406 is shown to store the efficient data for future use. In some example embodiments, the coefficient computation engine calculates the coefficient data with a censored regression algorithm. Some example embodiments may include, the use of the feature optimization engine to calculate the optimized suggestion data with a non-linear mixed integer optimization and non-linear constraint algorithm. In some example embodiments, a retriever 407 is shown to retrieve a business constraint, and to use the business constraint to determine the profit value generated by the selected features inclusion on the webpage. Additionally, the retriever 407 may be used to retrieve default values to be used in a determination of the profit value generated by associating the selected feature and the webpage.

In some example embodiments, a receiver 408 is illustrated to receive optimized suggestion data that includes a profit value generated by associating a selected feature and a webpage. A selection engine 409 is shown to select a newly selected feature to be included on the webpage. In some example embodiments, the selected features include at least one of the following features: a starting price feature, a reserve price feature, a blemish feature, a new item feature, an auction duration feature, positive feedback feature, a seller experience feature, buy it now feature, a get it fast feature, payment processor item feature, gallery feature, subtitle feature, a listing designer feature, a value pack feature, a bold feature, a border feature, highlight feature, a gallery featured feature, a featured plus feature, a propack feature, a scheduled listing feature, a 10-day duration feature, a gift services feature, a home page featured feature, a two categories listing feature, a picture feature, a extra picture feature, a super size picture feature, a picture pack feature, a number similar auctions feature, a shipping cost feature, a num items seller feature, a insertion fee feature, a reserve fee feature, or a final value fee feature. The selection engine 409 may be used to select a feature to be included on the webpage.

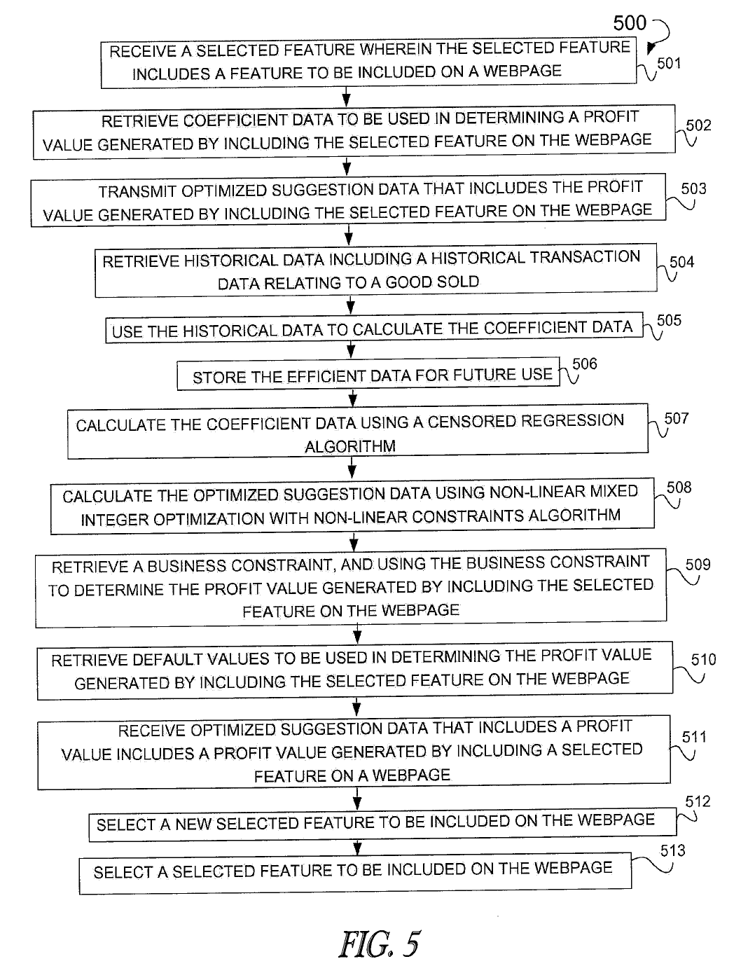

FIG. 5 is a flow chart illustrating an example method 500 used to generate optimized selection data 200. Shown are various operations 501 through 506 that are executed by a feature optimization server 210. Illustrated is an operation 501 that, when executed, receives a selected feature wherein the selected feature includes a feature to be included on a webpage. An operation 502 is also shown that, when executed, retrieves coefficient data to be used in determining a profit value generated by including the selected feature on the webpage. Operation 503 is shown that, when executed, transmits optimized suggestion data that includes the profit value generated by including the selected feature on the webpage. Additionally, operation 504, when executed, retrieves historical data including historical transaction data relating to goods sold. Operation 505, when executed, uses historical data to calculate coefficient data. Additionally, operation 506, when executed, stores the coefficient data for future use.

In some example embodiments, various operations 507 through 510 residing on the coefficient computation server 109 are executed. An operation 507 is show, that, when executed, calculates coefficient data using a censored regression algorithm. Additionally, an operation 508 is illustrated that, when executed, calculates the optimized suggestion data using non-linear mixed integer optimization with non-linear constraints algorithm. An operation 509, when executed, retrieves a business constraint, and using the business constraint determines the profit value generated by including the selected feature on the webpage. Operation 510, when executed, retrieves default values to be used in determining the profit value generated by including the selected feature on the webpage.

Some example embodiments may include operations 511 and 512 implemented on a device 102. Shown is an operation 511 that, when executed, receives optimized suggestion data that includes a profit value generated by including a selected feature on a webpage. An operation 512 is shown that, when executed, selects a new selected feature to be included on the webpage. In some example embodiments, the selected feature includes at least one of the following features: a starting price feature, a reserve price feature, a blemish feature, a new item feature, an auction duration feature, positive feedback feature, a seller experience feature, buy it now feature, a get it fast feature, payment processor item feature, gallery feature, subtitle feature, a listing designer feature, a value pack feature, a bold feature, a border feature, highlight feature, a gallery featured feature, a featured plus feature, a propack feature, a scheduled listing feature, a 10-day duration feature, a gift services feature, a home page featured feature, a two categories listing feature, a picture feature, a extra picture feature, a super size picture feature, a picture pack feature, a number similar auctions feature, a shipping cost feature, a num items seller feature, a insertion fee feature, a reserve fee feature, or a final value fee feature. Some example embodiments may include an operation 513 that, when executed, selects feature to be included on the webpage.

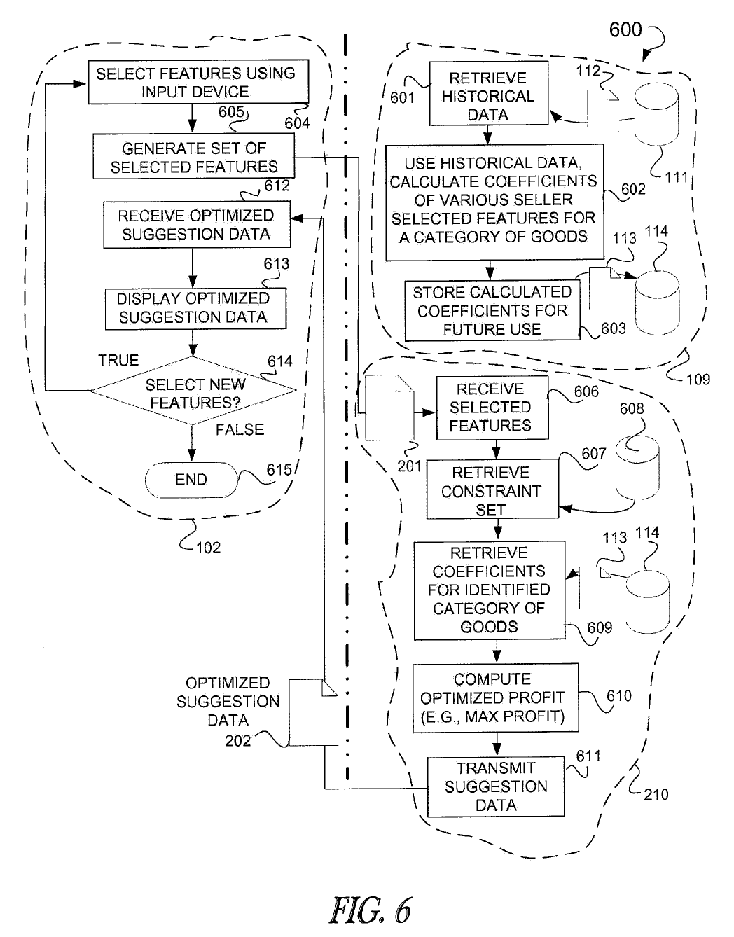

FIG. 6 is a diagram of a dual-stream flowchart illustrating an example method 600 used to generate optimized suggestion data 202. Shown is a first stream illustrating operations 604 though 605, and operations 612 through 615. These various operations may reside and be executed by, for example, one of more of the devices 102. Also shown are operations 601 through 603 that may reside on or be executed by, for example, the coefficient computation server 109. Further, operations 606 through 611 are shown that may reside as a part of, or be executed by, the feature optimization server 210.

Starting with the operation 601, in some example embodiment, an operation 601 is executed that retrieves the historical data 112 from the historical transaction data 111 database. An operation 602 is executed that uses this historical data to calculate coefficients of various seller selected features for a category of goods. As previously referenced, these category goods may include cameras, jewelry, clothing, or some other suitable category of goods or services. An operation 603 may be executed that stores this calculated coefficient data 113 for future use into the coefficient data 114 database. In some example embodiments, once the coefficient data 113 is stored into the coefficient data 114 database, the seller 101 may be free to select features and generated selected features 201 data. An operation 604 may be executed wherein features are selected using an input device. An operation 605 may be executed that generates a set of selected features, such as selected features 201, and transmits this set of selected features 201 across the network 108 to be received through the execution of an operation 606. An operation 607 may be executed that retrieves a constraint set from constraint set data 608 database. An operation 609 may be executed that retrieves coefficients relating to an identified category of good from the coefficient data 114 database. These coefficients may be retrieved as coefficient data 113. An operation 610 may be executed that may compute optimized profit for a particular category of goods utilizing the coefficient data 113. An operation 611 may be executed that transmits the suggestion data as optimized suggestion data 202 back across the network 108 to be received through the execution of operations 612. Operation 613 may be executed that displays the optimized suggestion data in the GUI 107 for the seller 101. In certain example embodiments, a decisional operation 614 may be executed that determines whether or not the seller 101 has decided to select a subset of the optimized suggestion data 202 so as to implement certain selected features on their webpage. In cases where decisional operation 614 evaluates to “true,” the operation 604 is re-executed. In cases where decisional operation 614 evaluates to “false,” a termination condition 615 is executed. Some of these operations will be more fully discussed below.

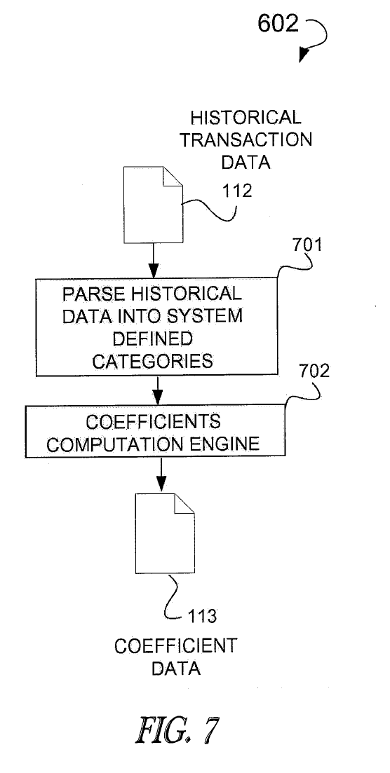

FIG. 7 is a flowchart illustrating the execution of an example method 602. Shown is the historical transaction data 112 that is processed through the execution of operation 701. Operation 701, when executed, parses this historical data into the system defined categories. These categories may include, for example, camera, jewelry, clothing, or some other predefined category. An operation 702 may then be executed that acts as a coefficient computation engine. As will be more fully illustrated below, this coefficient computation engine may utilize a likelihood function to determine the coefficients associated with a regression model used to determine, for example, a profit value for the site host, a profit value for the seller 101, or some other suitable value. Once these coefficients for a particular defined category of goods are computed, then the coefficient data 113 is generated and stored into the coefficient 114 database.

In some example embodiments, the operation 702 implements a censored regression algorithm in the form of a likelihood function. As a threshold matter, a regression model is constructed by the site host. This site host may, for example, support on-line auctions. Within the on-line auction context, a number of considerations may need to be taken into account. One example consideration is that a given auction might not actually results in a transaction since either the reserved price (e.g., a minimum price set by the seller) may not be met, or the auction had no bids at all. These cases are included in the modeling outlined below since the lack of auction success still contains useful information regarding possible factors which influence the outcome of an auction. A further example consideration is the case of zero bids, wherein the maximal bid price variable is censored at the minimal bid level. Specifically, the latent auction price may not be observed because of a high minimum bid. In such a case, one approach may be to consider the maximal bid as a proxy for final sold price.

Assuming the above considerations, in some example embodiments, a censored regression model is shown wherein a first equation has the form:

Max_bid=Max_bid* if Max_bid>0(the auction is successful)=starting_price.

Next, a second maximal auction bid equation is generated having the linear additive form:

Max_bid*_{iεS,t}=const+α_{reg,S}*starting_price_{iεS,t}+β_{reg,S}*reserve_price_{iεS,t}+γ_{reg,S}*bemish_{iεS,t}+η_{reg,S}*positive_feedback_{iεS,t}+λ_{reg,S}*seller_experience_{iεS,t}+ω_{reg,S}*value_pack_{iεS,t}+ψ_{reg,S}*bold_{iεS,t}+ . . . +εₜ

where εₜ is a stochastic random error term at time t—which is assumed to follow normal distribution with zero mean and constant σ−N(0,σ). These first two equations are evaluated using a maximum likelihood function having the form:

$$L ( β , σ ) = {\prod }_{i = 1}^{N} {{Φ ( - \frac{{X}_{i} β}{σ} )}^{I [ {Max\_bid}_{i} <= 0 ]} [ \begin{matrix}\frac{1}{σ \sqrt{2 π}} \\ exp ( - \frac{1}{2 {σ}^{2}} {( {Max\_bid}_{i} - {X}_{i} β )}^{2}\end{matrix} ]}^{I [ {Max\_bid}_{i} > 0 ]}$$

where solving for β and σ, the first term gives the probability that the observation is censored written as:

Pr[Max_bidᵢ<=01Xᵢ]=Pr[Xᵢβ+εᵢ<01Xᵢ]=Pr[εᵢ<=−Xᵢ||Xᵢ]=Φ(−Xᵢβ′/σ)

and the second term is the density of non-censored observation which is a standard normal density. “I” may be the indicator variable which allows for switching between censored and non-censored observations, and Φ is the cumulative density function for the normal distribution, and σ is the variance of the error term of the second equation.

In some example embodiments, the expectation of the Max_bidᵢ variable of the second equation is conditional upon the vector of independent variables \vec{X}ᵢ and is given by the following equation:

$$\begin{matrix}E ( {Max\_bid}_{i} \vert {X}_{i} ) = Pr [ {Max\_bid}_{i} = {starting\_price}_{i} \vert {X}_{i} ] \\ E [ {Max\_bid}_{i} \vert {Max\_bid}_{i} = {starting\_price}_{i} , {X}_{i} ] + \\ Pr [ {Max\_bid}_{i} > 0 \vert {X}_{i} ] E [ {Max\_bid}_{i} \vert {Max\_bid}_{i} > 0 , {X}_{i} ] \\ = Φ ( - {β}^{′} {X}_{i} / σ ) {starting\_price}_{i} + \\ Φ ( \frac{{β}^{′} {X}_{i}}{σ} ) ( {β}^{′} {X}_{i} + σ \frac{φ ( {β}^{′} {X}_{i} / σ )}{Φ ( {β}^{′} {X}_{i} / σ )} )\end{matrix}$$

where

$$φ ( x ) = \frac{1}{\sqrt{2 π}} exp ( - {x}^{2} / 2 )$$

is the normalized probability density function for normal distribution; and

$$Φ ( y \vert μ , σ ) = {\int }_{- ∞}^{y} φ d x$$

is the cumulative distribution function for normal distribution. The first term may take into account the fact that the censoring occurs at the starting price and the second term is the contribution of a standard Tobit model with zero censoring.

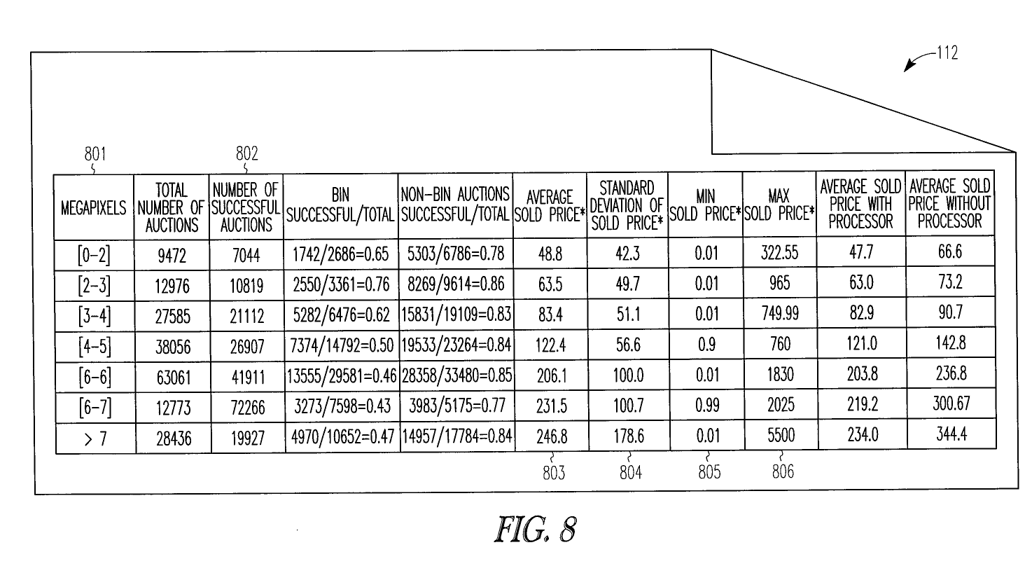

FIG. 8 is a diagram illustrating the example historical transaction data 112. Shown is historical transaction data 112 represented in a tabular format. Illustrated is a column 801 containing a description of a particular category of goods represented here as, for example, mega pixels associated with a particular type of camera. Further, a column 802 is shown describing the number of successful auctions for a particular category of goods. Additionally, table 803 is shown reflecting the average sold price for a category of goods. A column 804 is also shown that reflects the standard deviation of price. Further, a column 805 is shown reflecting the minimum seller price for a particular category of goods. Additionally, a column 806 is shown reflecting a maximum seller price for a particular category of goods. This tabular format may be dictated by particular database query language that may be used to access the historical transaction 111 database. This query language may, as will be more fully described below, include, a Structured Query Language (SQL), a Multidimensional Expression Language (MDL), or some other suitable query language.

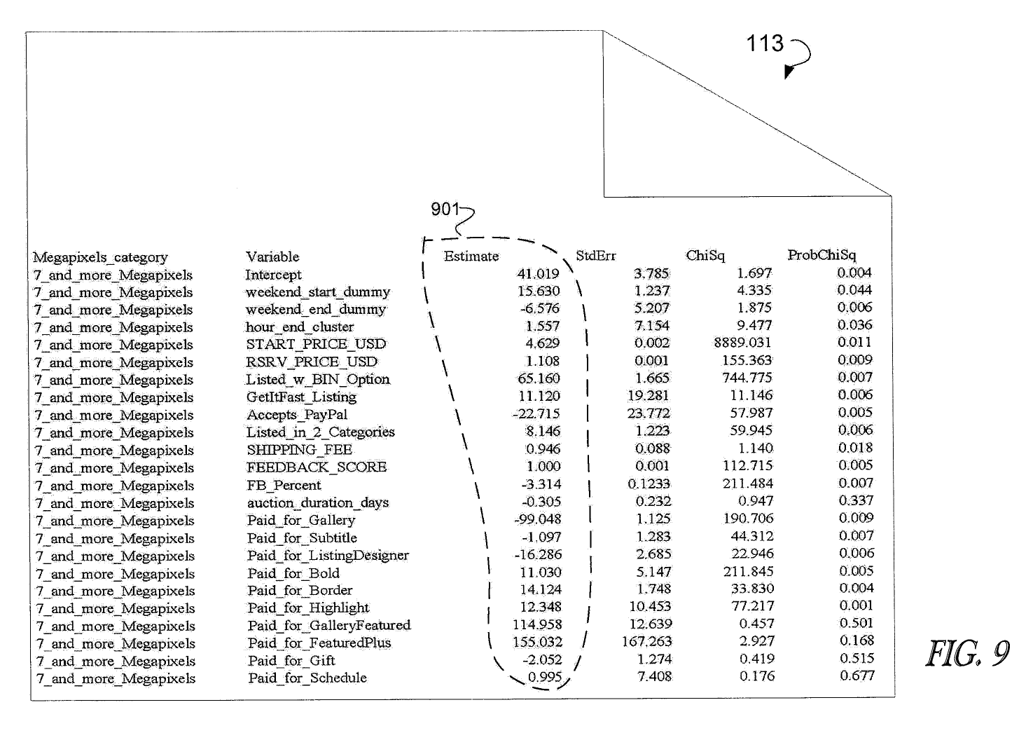

FIG. 9 is a diagram illustrating example coefficient data 113. Shown is coefficient data 113 represented in a table 901. Contained within this table 901 are actual coefficient values that may be associated with certain selected features that may or may not be chosen by, for example, the seller 101. A coefficient value, as illustrated, may be positive or negative in nature and may be modified based upon additional historical transaction data provided to the historical transaction 111 database.

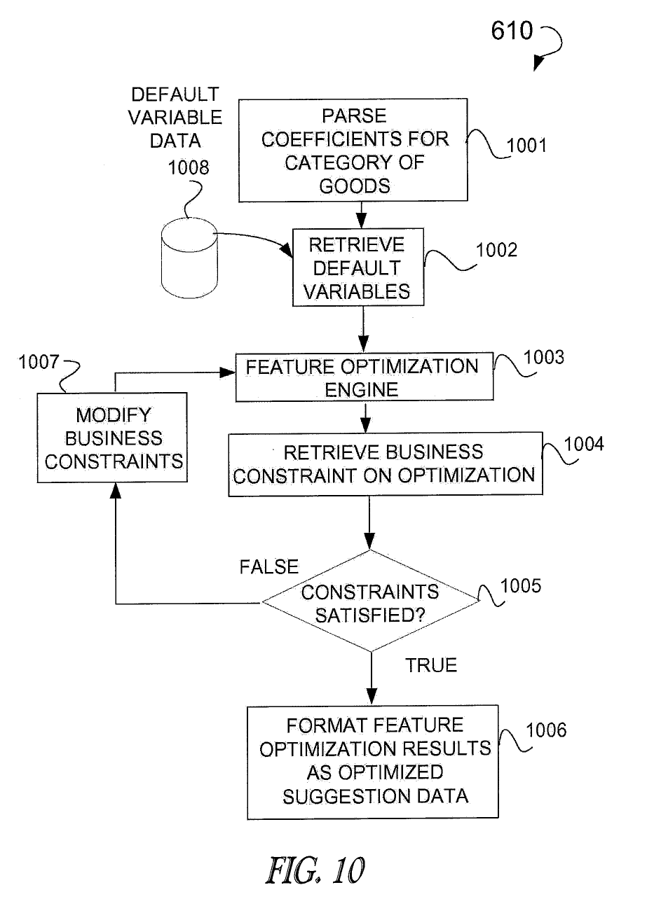

FIG. 10 is a flowchart illustrating the example method 610. Shown is an operation 1001 that, when executed, is used to parse coefficients for a particular category of goods. These coefficients may be obtained from, for example, the coefficient data 113. An operation 1002 is also shown that, when executed, may retrieve default variables from a default variable data 1008 database. This default variable data contained within the default variable data 1008 database may be dictated by a site host. This default variable data may be used to dictate various default features that were not or have not been selected by the seller 101 in designing their webpage. These default variables may include, for example, a default price as defined the site host or the seller, a default shipping cost as defined by the site host or seller, or some other suitable default value. In some example embodiments, any of the independent variables (e.g., the features) listed above may be represented as a default variable. Further, an operation 1003 is shown that constitutes a feature optimization engine. This feature optimization engine, as is more fully described below, may determine profit for a host, profit for a seller, or some other type of profit utilizing amongst other things the coefficient data 113 for a particular category of goods or services. An operation 1004 is also shown that may retrieve certain business constrains that may be met for the purposes of optimization. These business constraints may include, for example, ensuring that the profit for a seller is greater than or equal to the default profit for a seller. Other types of business constraints may also be implemented. A decisional operation 1005 is also shown that determines whether or not the constraints as retrieved by operation 1004 have been satisfied. In cases where decisional operation 1005 evaluates to be “true,” an operation 1006 is executed to format certain feature optimization results as optimized suggestion data 202. In cases where decisional operation 1005 evaluates to “false,” an operation 1007 is executed that modifies the business constraints. Once these business constraints are modified, the previously shown operation 1003 is re-executed.

In some example embodiments, the operation 1003 may utilize the coefficients for certain categories of goods to generate optimized suggestion data. For example, the expected profit for an on-line auction site (e.g., site host) in the sale of a good or service (e.g., an item) may be represented as item iεS at a price=Max_bid_{iεS} where:

Profit_Sitehost_{iεS}=Λ*Max_bid_{iεS}+α*starting_price_{iεS}+β*reserve_price+ω*value_pack_{iεS}+τ*eBay_keywords_{iεS}+ψ*bold_{iεS}+ . . .

where Λ is the final value fee, α is the insertion fee, β is the fee for using secret reserved price, ω is the fee charged to the seller who chooses to use the value pack, and τ is the fee for buying the keywords prior to the auction. In some example embodiments, by inserting the previously determined regression equation for the expected max_bid (e.g., the second maximal auction bid equation reference above), the profit equation takes the following form:

$${Profit\_sitehost}_{i ∈ {S}_{i}} = Λ * ( Φ ( - {β}^{′} {X}_{i} / σ ) {starting\_price}_{i} + Φ ( \frac{{β}^{′} X}{σ} ) [ \hat{const} + {\hat{α}}_{reg , S} * {starting\_price}_{i ∈ {S}_{i}} + {\hat{β}}_{reg , S} * {reserve\_price}_{i ∈ {S}_{i}} + {\hat{γ}}_{reg , S} * {blemish}_{i ∈ S} + {\hat{η}}_{reg , S} * {positive\_feedback}_{i ∈ S} + {\hat{λ}}_{reg , S} * {seller\_experience}_{i ∈ S} + {\hat{ω}}_{reg , S} * {value\_pack}_{i ∈ S} + {\hat{ψ}}_{reg , S} * {bold}_{i ∈ S} + … + σ \frac{φ ( {β}^{′} X / σ )}{Φ ( {β}^{′} X / σ )} \vert ) + α * {starting\_price}_{i ∈ S} + β * {reserve\_price}_{i ∈ S} + ω * {value\_pack}_{i ∈ S} + τ * {eBay\_keywords}_{i ∈ S} + ψ * {bold}_{i ∈ {S}^{=}} + …$$

where the “reg” underscore is used to distinguish the regression coefficients from a-priori fixed fee factors, β is the vector of regression coefficients, and X is the vector of independent variables.

In some example embodiments, the objective of the site host is to maximize profit such that the function Profit_host_{iεS} is defined over a set of item-specific decision variables var_{iεS} (e.g., starting_price, reserve_price, value_pack etc). Additionally, the equation: va\hat{r}_{iεS}=arg maxᵥₐᵣ_{_{iεS}} Profit_sitehost_{iεS}(var_{iεS}) may be used subject to the constraint that the seller's profit should be greater than or equal to the default values. The default value (e.g., a default variable) may correspond to the expected profit with the variables originally selected by the seller at the start of the auction. That is, the expected seller's profit under the scenario “optimal,” from the site host's point-of-view, takes the form:

$${Profit\_seller}_{i ∈ S} = ( 1 - Λ ) * Φ ( \frac{{β}^{′} X}{σ} ) [ \hat{const} + {\hat{α}}_{reg , S} * {starting\_price}_{i ∈ S} + {\hat{β}}_{reg , S} * {reserve\_price}_{i ∈ S} + {\hat{γ}}_{reg , S} * {blemish}_{i ∈ S} + {\hat{η}}_{reg , S} * {postive\_feedback}_{i ∈ S} + {\hat{λ}}_{reg , S} * {seller\_experience}_{i ∈ S} + {\hat{ω}}_{reg , S} * {value\_pack}_{i ∈ S} + {ψ}_{reg , S} * {bold}_{i ∈ S} + … + σ \frac{φ ( {β}^{′} X / σ )}{Φ ( {β}^{′} X / σ )} - α * {starting\_price}_{i ∈ S} - β * reserve\_price - ω * {value\_pack}_{i ∈ S} - τ * {sitehost\_keywords}_{i ∈ S} - ψ * {bold}_{i ∈ S} - ( shipping\_fee \_average - shipping\_fee \_optimal ) - …$$

In some example embodiments, the default seller's profit takes into account only the variables originally selected by the seller prior to any recommendations by the host. The coefficients for the remaining variables that are not included in the seller's original choice are set to zero. The last term in the above equation assumes that the seller makes some extra profit if he is able to ship below the average shipping cost for all the items in the category.

In some example embodiments, in order for the host site to make additional recommendations on-top of the default variables selected by the seller, the seller's profit under the hosts optimal scenario must be at least as large as the seller's default profit such that: Profit_seller_{iεS}≧Profit_seller_default_{iεS}. The other constraints are that the starting and reserve prices must be non-negative, various marketing features can only take binary values, the expected maximal bid is at least as large as the starting or reserve price etc. That is,

starting_price,reserve_price≧0;value_pack,bold . . . ε{0;1}.

### Example Storage

Some embodiments may include the various databases (e.g., 111, 114, and 1008) being relational databases, or in some cases OLAP based databases. In the case of relational databases, various tables of data are created and data is inserted into, and/or selected from, these tables using SQL, or some other database-query language known in the art. In the case of OLAP databases, one or more multi-dimensional cubes or hypercubes containing multidimensional data from which data is selected from or inserted into using MDX may be implemented. In the case of a database using tables and SQL, a database application such as, for example, MYSQL™, SQLSERVER™, Oracle 8I™, 10G™, or some other suitable database application may be used to manage the data. In this, the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, optimization algorithm known in the art.

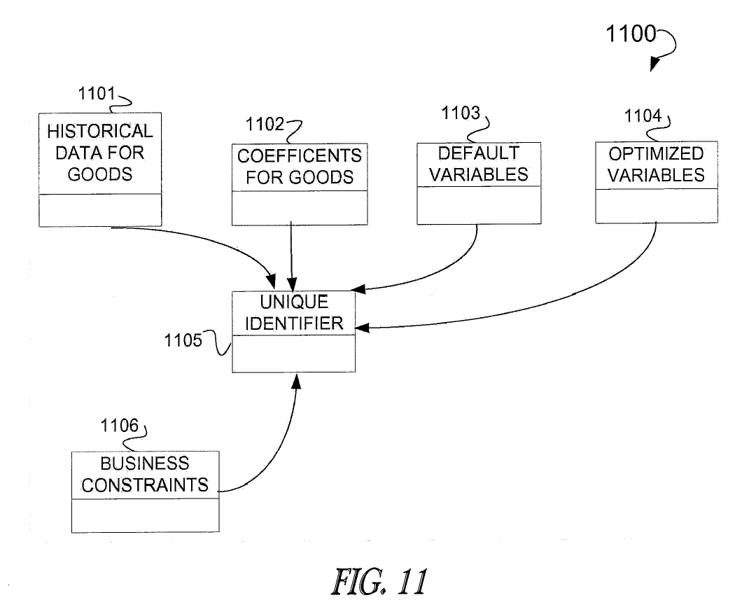

FIG. 11 is an example Relational Data Schema (RDS) 1100 illustrating various tables of data that may be utilized during the course of implementing the system and method described herein. Shown is a table 1101 containing historical data for particular goods or services, or categories of goods or services. Data types used to store this historical data may include, for example, floats, doubles, string, or some other suitable data type. Also shown is a table 1102 that contains coefficients for goods or categories of goods. Data types used to store these coefficients or codes may include floats, doubles, or some other suitable data types. Also shown is a table 1103 used to store default variables dictated by, for example, a site host. These default variables include strings, eXtensible Markup Language (XML) data types, boolean data types, integer data types, or some other suitable data type. Also shown is a table 1104 containing optimized variables. These optimized variables may be stored utilizing data types including, for example, strings, integers, floats, or some other suitable data type. Some example embodiments in XML data type may be used for the data within table 1104. Also shown is a table 1106 containing certain business constraints. These business constraints may be stored as for example a boolean, XML, string, integer, float, or some other suitable data type. A table 1105 is shown that may provide a unique identifier value to uniquely identify the data contained in each of the tables 1101 through 1104, and 1106. This unique identifier value may be an integer data type.

### Example Three-Tier Architecture

In some embodiments, a method is illustrated as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend, or storage tier. These logical/mathematical manipulations may relate to certain business rules, or processes that govern the software application as a whole. A third, storage tier, may be a persistent storage medium or, non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or so some other suitable configuration. Further, these three tiers may be distributed between more than one computer system as various software components.

### Example Component Design

Some example embodiments may include the above illustrated tiers, and processes or operations that make them up, as being written as one or more software components. Common too many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Example Distributed Computing Components and Protocols

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, an component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) stack model for defining the protocols used by a network to transmit data.

### Example System of Transmission Between a Server and Client

Some embodiments may utilize the OSI model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, LAN, WAN, or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

### Example Computer System

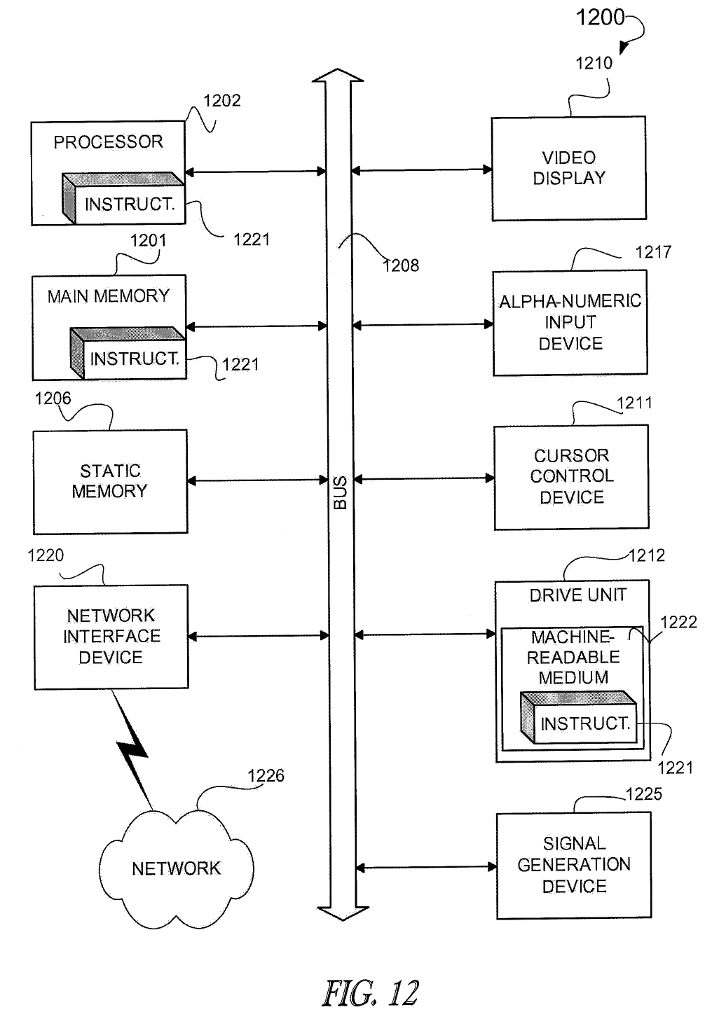

FIG. 12 shows a diagrammatic representation of a machine in the example form of a computer system 1200 that executes a set of instructions to perform any one or more of the methodologies discussed herein. One of the devices 102 may configured as a computer system 1200. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1200 includes a processor 1202 (e.g., a Central Processing Unit (CPU), a Graphics Processing Unit (GPU) or both), a main memory 1201, and a static memory 1206, which communicate with each other via a bus 1208. The computer system 1200 may further include a video display unit 1210 (e.g., a Liquid Crystal Display (LCD) or a Cathode Ray Tube (CRT)). The computer system 1200 also includes an alphanumeric input device 1217 (e.g., a keyboard), a GUI cursor controller 1211 (e.g., a mouse), a disk drive unit 1212, a signal generation device 1225 (e.g., a speaker) and a network interface device (e.g., a transmitter) 1220.

The drive unit 1212 includes a machine-readable medium 1222 on which is stored one or more sets of instructions and data structures (e.g., software) embodying or used by any one or more of the methodologies or functions illustrated herein. The software may also reside, completely or at least partially, within the main memory 1201 and/or within the processor 1202 during execution thereof by the computer system 1200, the main memory 1201 and the processor 1202 also constituting machine-readable media.

The instructions 1221 may further be transmitted or received over a network 1212 via the network interface device 1220 using any one of a number of well-known transfer protocols (e.g., HTTP, Session Initiation Protocol (SIP)).

The term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Example Marketplace Applications

In some example embodiments, a system and method is shown for generating coefficient data and using this coefficient data to facilitate the generation of optimized suggestion data. A seller may select certain features that they want to appear on their website. This website may be used to facilitate the sale of a good or service. In one example embodiment, the suggestions are made to the seller by a site host as to features that the seller may want to choose to optimize the website for the purpose of maximizing profit for the sell and/or for the site host. The seller may be provided with optimized suggestion data that may compare and contrast the features selected by the seller against those suggested by the site host. The seller may then be free to select these features, or decline to accept these features.

The Abstract of the Disclosure is provided to comply with 37 C.F.R. § 1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
receiving a selected feature wherein the selected feature includes a feature to be included on a webpage;
retrieving coefficient data to be used in determining a profit value generated by including the selected feature on the webpage; and
transmitting optimized suggestion data that includes the profit value generated by including the selected feature on the webpage.

2. The computer implemented method of claim 1, further comprising:
retrieving historical data including a historical transaction data relating to a good sold;
using the historical data to calculate the coefficient data; and
storing the coefficient data for future use.

3. The computer implemented method of claim 1, further comprising calculating the coefficient data using a censored regression algorithm.

4. The computer implemented method of claim 1, further comprising calculating the optimized suggestion data using non-linear mixed integer optimization with non-linear constraints algorithm.

5. The computer implemented method of claim 1, further comprising retrieving a business constraint, and using the business constraint to determine the profit value generated by including the selected feature on the webpage.

6. The computer implemented method of claim 1, further comprising retrieving default values to be used in determining the profit value generated by including the selected feature on the webpage.

7. A computer implemented method comprising:
receiving optimized suggestion data that includes a profit value generated by including a selected feature on a webpage; and
selecting a new selected feature to be included on the webpage.

8. The computer implemented method of claim 6, wherein the selected feature includes at least one of the following features: a starting price feature, a reserve price feature, a blemish feature, a new item feature, an auction duration feature, positive feedback feature, a seller experience feature, buy it now feature, a get it fast feature, payment processor item feature, gallery feature, subtitle feature, a listing designer feature, a value pack feature, a bold feature, a border feature, highlight feature, a gallery featured feature, a featured plus feature, a propack feature, a scheduled listing feature, a 10-day duration feature, a gift services feature, a home page featured feature, a two categories listing feature, a picture feature, a extra picture feature, a super size picture feature, a picture pack feature, a number similar auctions feature, a shipping cost feature, a num items seller feature, a insertion fee feature, a reserve fee feature, or a final value fee feature.

9. The computer implemented method of claim 7, further comprising selecting a selected feature to be included on the webpage.

10. A computer system comprising:
a receiver to receive a selected feature wherein the selected feature includes a feature to be included on a webpage;
a feature optimization engine to retrieve coefficient data to be used to determine a profit value generated through the association of the selected feature with the webpage; and
a transmitter to transmit optimized suggestion data that includes the profit value generated by including the selected feature on the webpage.

11. The computer system of claim 10, further comprising:
a retriever to retrieve historical data including historical transaction data that relates to a good sold;
a coefficient computation engine to use the historical data to calculate the coefficient data; and
a storage engine to store the efficient data for future use.

12. The computer system of claim 11, wherein the coefficient computation engine calculates the coefficient data with a censored regression algorithm.

13. The computer system of claim 10, wherein the feature optimization engine calculates the optimized suggestion data with a non-linear mixed integer optimization and non-linear constraint algorithm.

14. The computer system of claim 10, further comprising a retriever to retrieve a business constraint, and to use the business constraint to determine the profit value generated by the selected feature's inclusion on the webpage.

15. The computer system of claim 10, further comprising a retriever to retrieve default values to be used in a determination of the profit value generated by associating the selected feature and the webpage.

16. A computer system comprising:
a receiver to receive optimized suggestion data that includes a profit value includes a profit value generated by associating a selected feature and a webpage; and
a selection engine to select a new selected feature to be included on the webpage.

17. The computer system of claim 16, wherein the selected feature includes at least one of the following features: a starting price feature, a reserve price feature, a blemish feature, a new item feature, an auction duration feature, positive feedback feature, a seller experience feature, buy it now feature, a get it fast feature, payment processor item feature, gallery feature, subtitle feature, a listing designer feature, a value pack feature, a bold feature, a border feature, highlight feature, a gallery featured feature, a featured plus feature, a propack feature, a scheduled listing feature, a 10-day duration feature, a gift services feature, a home page featured feature, a two categories listing feature, a picture feature, a extra picture feature, a super size picture feature, a picture pack feature, a number similar auctions feature, a shipping cost feature, a num items seller feature, a insertion fee feature, a reserve fee feature, or a final value fee feature.

18. The computer system of claim 16, wherein the selection engine selects a selected feature to be included on the webpage.

19. An apparatus comprising:
means for receiving a selected feature wherein the selected feature includes a feature to be included on a webpage;
means for retrieving coefficient data to be used in determining a profit value generated by including the selected feature on the webpage; and
means for transmitting optimized suggestion data that includes the profit value generated by including the selected feature on the webpage.

20. A machine-readable medium comprising instructions, which when implemented by one or more machines cause the one or more machines to perform the following operations:
receiving a selected feature wherein the selected feature includes a feature to be included on a webpage;
retrieving coefficient data to be used in determining a profit value generated by including the selected feature on the webpage; and
transmitting optimized suggestion data that includes the profit value generated by including the selected feature on the webpage.
